(19) United States
(12) Patent Application Publication
(10) Pub. No.: US 2014/0229278 A1
(43) Pub. Date: Aug. 14, 2014

(54) SYSTEM AND PROCESS FOR TARGETED MOBILE ADVERTISING BASED ON WIRELESS SERVICE AND ASSOCIATED SHOPPING BEHAVIOR

(71) Applicant: TRACFONE WIRELESS, INC., Miami, FL (US)

(72) Inventors: Douglas COHEN, Miami, FL (US); Lavanya MANCHIKATLA, Miami, FL (US)

(73) Assignee: TRACFONE WIRELESS, INC., Miami, FL (US)

(21) Appl. No.: 13/767,280

(22) Filed: Feb. 14, 2013

(51) Int. Cl. G06Q 30/02

(52) U.S. Cl. CPC G06Q 30/0267
USPC 705/14.53

(57) ABSTRACT

A system and process to generate and send targeted advertising to wireless devices from a computer system is disclosed and includes determining a retail location where wireless service for a wireless device has been purchased utilizing the computer system. The process further include identifying information of the wireless device based on an authorization of the wireless service for the wireless device purchased at the retail location utilizing the computer system, determining a previous history of purchasing wireless service associated with the wireless device of the consumer utilizing the computer system, determining a next likely time the consumer will be purchasing wireless service for the wireless device utilizing the computer system, and sending advertisements prior to the next likely time the consumer will be purchasing wireless service for the wireless device utilizing the computer system.

### FIELD OF THE INVENTION

The invention relates to a system and process for providing targeted mobile advertising based on purchasing patterns of users of prepaid wireless service. In particular, the invention relates to a system and process for providing targeted mobile advertising based on purchasing patterns of users of prepaid wireless service and associated purchasing of goods and services at the same retailer.

### BACKGROUND

Prior art systems and processes for providing mobile advertising typically provide mobile advertisements to a mobile user without any knowledge of when the mobile user will typically shop, where the mobile user typically shops, and what the mobile user typically purchases. For example, an advertiser may simply randomly send text messages to mobile users advertising goods and services with little or no knowledge of the mobile user. This advertising typically is of little interest to the mobile user. This is because the advertising cannot be targeted to when the mobile user is shopping, where the mobile user is shopping, and for what items the mobile user may possibly be interested in purchasing.

Many mobile users find pre-paid wireless services attractive. Providers offering pre-paid wireless services allow the user the option of paying for a predetermined amount of wireless services prior to using the service. For example, the predetermined amount of wireless service can be purchased at a retailer. The retailer can provide a card having an authorization code, an authorization code (without a card), authorization of wireless service (without a card or code), or the like to obtain a predetermined amount of wireless service. Whether the mobile user obtains wireless service from a pre-paid wireless service or from a postpaid wireless service, the random advertising described above can be wasted and can be of little interest to the mobile user.

Because advertising cannot be targeted to the mobile user, there is a need for a system and process to be able to determine when a mobile user is likely to go shopping, where the mobile user may likely be shopping, and what items the mobile user may be interested in purchasing.

### SUMMARY OF THE INVENTION

The foregoing needs are met, to a great extent, by the invention, wherein in one aspect a system and process are provided to determine when a mobile user is likely to shop, where the mobile user is likely to shop, and for what items the mobile user may possibly be interested in purchasing.

In accordance with one aspect, a system configured to generate and send targeted advertising to wireless devices includes a server configured to determine a retail location where wireless service for a wireless device has been purchased, the server further configured to determine identifying information of the wireless device based on an authorization of the wireless service for the wireless device purchased at the retail location, the server further configured to determine a previous history of purchasing wireless service associated with the wireless device of the consumer, the server further configured to determine a next likely time the consumer will be purchasing wireless service for the wireless device, and the server further configured to send advertisements prior to the next likely time the consumer will be purchasing wireless service for the wireless device.

In accordance with another aspect a system configured to generate and send targeted advertising to wireless devices includes means for determining a retail location where wireless service for a wireless device has been purchased, means for identifying information of the wireless device based on an authorization of the wireless service for the wireless device purchased at the retail location, means for determining a previous history of purchasing wireless service associated with the wireless device of the consumer, means for determining a next likely time the consumer will be purchasing wireless service for the wireless device, and means for sending advertisements prior to the next likely time the consumer will be purchasing wireless service for the wireless device.

In accordance with another aspect a process to generate and send targeted advertising to wireless devices from a computer system includes determining a retail location where wireless service for a wireless device has been purchased utilizing the computer system, identifying information of the wireless device based on an authorization of the wireless service for the wireless device purchased at the retail location utilizing the computer system, determining a previous history of purchasing wireless service associated with the wireless device of the consumer utilizing the computer system, determining a next likely time the consumer will be purchasing wireless service for the wireless device utilizing the computer system, and sending advertisements prior to the next likely time the consumer will be purchasing wireless service for the wireless device utilizing the computer system.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

FIG. 1 shows a schematic of a wireless device, multiple retailers, and networks in accordance with an aspect of the invention.

FIG. 2 shows an algorithm for capturing consumer/user information according to the invention.

FIG. 3 shows a process for providing advertisements to a consumer/user according to the invention.

FIG. 4 is a schematic of a system for providing advertisements to consumer/users according to the invention.

FIG. 5 shows an implementation of the process/system implemented on a wireless device according to the invention.

### DETAILED DESCRIPTION

The invention will now be described with reference to the drawing figures, in which like reference numerals refer to like parts throughout. Embodiments of the invention advantageously provide a system and process to determine when a mobile user is likely to shop, where they are likely to shop, and/or what they may be interested in purchasing. Additionally, the system and process are able to provide the advertising to the mobile user based on this information.

Reference in this specification to a wireless device is intended to encompass devices such as mobile phones, tablet computers, gaming systems, MP3 players and the like. Reference to a “wireless device” is intended to encompass any compatible mobile technology computing device that connects to a wireless communication network, such as mobile phones, mobile equipment, mobile stations, user equipment, cellular phones, smartphones, handsets or the like (e.g., Apple iPhone, iPad, Google Android based devices, BlackBerry based devices, other types of PDAs or smartphones), wireless dongles, or other mobile computing devices. The term “wireless device” may be interchangeably used and referred to herein as wireless handset, handset, mobile device, device, mobile phones, mobile equipment, mobile station, “user equipment, cellular phone, smartphones, or phone.

Wireless devices may connect to a wireless network or network and are intended to encompass any type of wireless network to obtain mobile phone services through the use of a wireless device, such as a Global System for Mobile Communication (GSM) network, Code-Division Multiple Access (CDMA) network or the like, that may utilize the teachings of the present application to allow a wireless device to connect to a wireless network.

Reference in this specification to “one aspect,” “an aspect,” “other aspects,” “one or more aspects” or the like means that a particular feature, structure, or characteristic described in connection with the aspect is included in at least one aspect of the disclosure. The appearances of, for example, the phrase “in one aspect” in various places in the specification are not necessarily all referring to the same aspect, nor are separate or alternative aspects mutually exclusive of other aspects. Moreover, various features are described which may be exhibited by some aspects and not by others. Similarly, various requirements are described which may be requirements for some aspects but not other aspects.

The invention is directed to a system and process that uses consumer shopping insights to target mobile users who shop at one or more retailers. The system and process may also determine how often the mobile user makes purchases at the one or more retailers. The system and process can hone in on those mobile users who visit a retailer of choice most often. The predictive modeling of the invention may display ads, provide text messages, send e-mails, or the like during a time period when the mobile user is most likely to revisit the one or more specific retailers. The invention provides a system and process to deliver relevancy and immediacy to mobile advertising efforts. The invention allows for mobile advertising that targets users based on where they shop, how often they shop there, or when they will shop there again.

Where They Shop

Using the system and process of the invention, an advertiser is able to target mobile users who shop at one or more retailers. The advertiser can distribute a coupon for the mobile user to use at the particular retailer, announce a new product launching, promote a seasonal special to mobile user, or the like.

How Often they Shop there

The system and process can also determine how mobile users transact purchases at a particular retailer. The system and process can hone in on those mobile users who visit the retailer of choice most often. The system and process can determine frequency of visits to a retailer in order to deliver high impact, relevant advertising campaigns.

When they Will Shop there Again

The system and process may utilize predictive modeling as a tool for targeting immediacy. With this tool, an advertiser's advertisements are displayed during the time period when the mobile user is most likely to revisit the retailer. This process can determine this based on airtime balance, service end date, previous buying behavior, remaining wireless service, and other indicative attributes. The predictive model of the system and process targets advertisements to mobile users during the critical period right before a shopping trip.

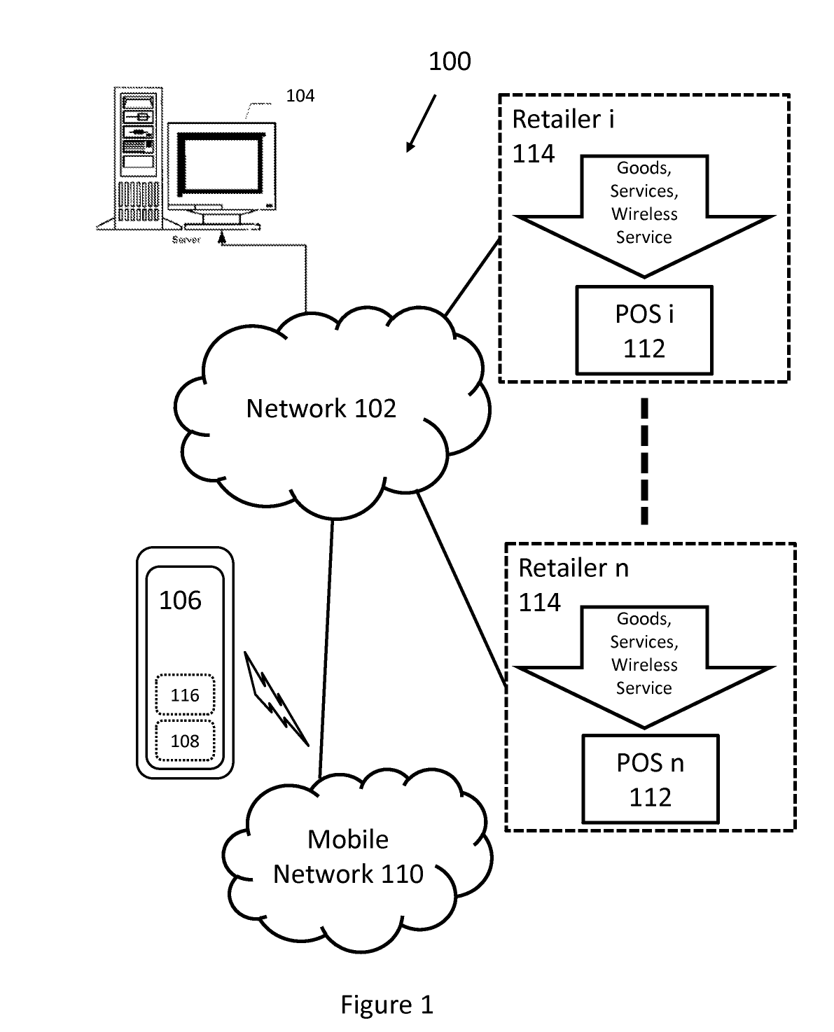

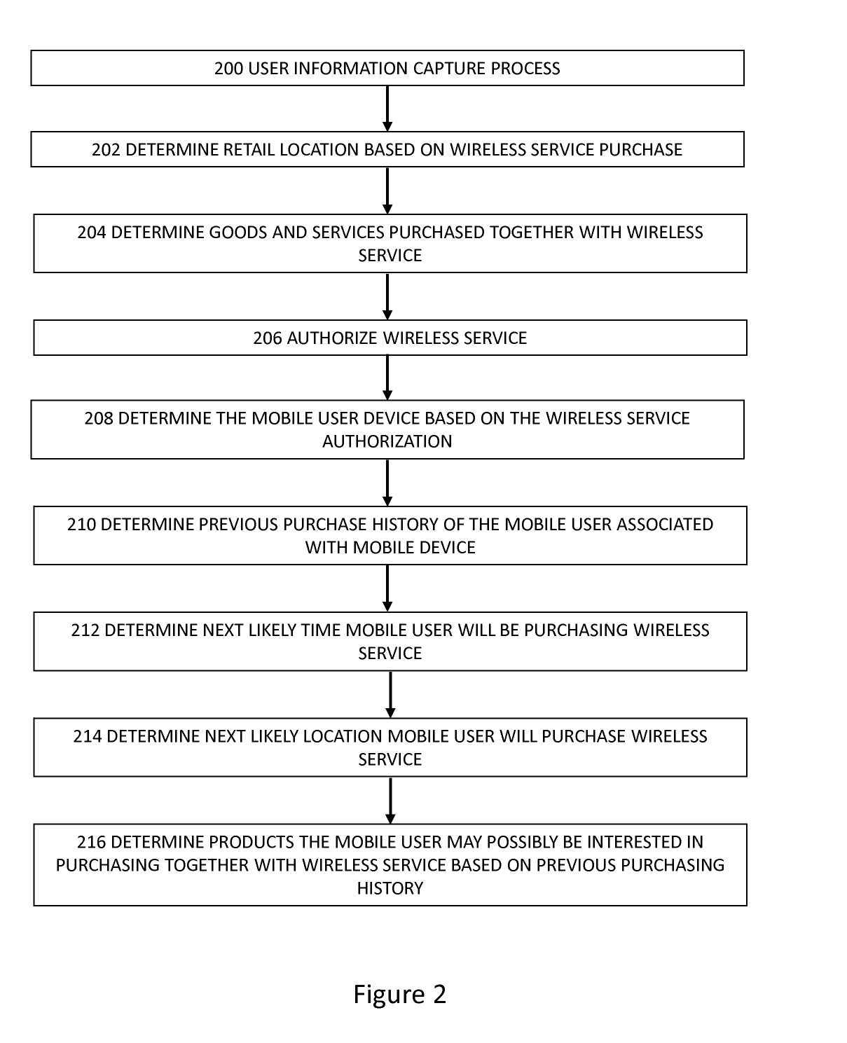

FIG. 1 shows a schematic of a wireless device, multiple retailers, and networks in accordance with an aspect of the invention; and FIG. 2 shows a process for capturing mobile user information according to the invention. In particular, a system 100 is shown in FIG. 1 that may include one or more aspects of a wireless device 106, a network 102, a server 104, and a mobile network 110. Referring further to FIG. 1, a consumer/mobile user associated with the wireless device 106 may from time to time visit the retailers 114 (including retailers i through n) and shop for various goods and services including shopping for wireless services for the wireless device 106. The wireless services may be purchased as a card having an authorization code, an authorization code (without a card), authorization of wireless service (without a card or code), or the like.

At the point-of-sales 112 (including point-of-sale i through n), the consumer/user may purchase the various goods and services including the wireless service for the wireless device 106. For example, at the point-of-sale 112 the wireless service may be associated with an authorization card that may be authorized by the prepaid wireless provider during a point-of-sale transaction in order to enable the authorization card and associated code to provide airtime for the mobile user and their wireless device 106 for use in the mobile network 110. Alternatively, during this point-of-sale transaction, the particular retailer 114 may be associated with the authorization card purchase based on identification information associated with the authorization card. In a further alternative, the consumer/user purchasing wireless service from the retailer 114 in other forms may associate the mobile user with a particular retailer based on identification information associated with the purchased wireless service and the wireless device 106 that utilizes the purchased wireless services. FIG. 2 shows the user information capture process 200 associated with the system 100 described above. In particular, the system 100 described above may implement a process of determining a retail location based on a wireless service purchase 202 as shown in FIG. 2 as described above for example. In this regard, however the wireless service purchase is completed, the purchased wireless service may include identification information that associates the wireless service purchase to the particular retailer and furthermore associates the purchase of wireless service to a particular wireless device 106 of the consumer/user. For example, the consumer/user purchases prepaid wireless service that includes identification information associated with the wireless service from ABC market. ABC market authorizes the wireless surface during the point-of-sale transaction and transmits the identification information relating to the wireless service to the prepaid wireless service provider. Accordingly, the prepaid wireless service provider has information associating the retailer with a particular wireless service purchase.

Additionally, during this retail transaction, the retailer 114 at the point-of-sale 112 may additionally provide the system 100 with a listing of the other goods and services that were purchased together with the wireless service. In particular, the process may include determining the goods and services purchased with the wireless service as shown in 204 of FIG. 2. More specifically, at the point-of-sale 112 each of the goods and services purchased by a consumer/user together with identification of a particular wireless service may be transmitted from the retailer 114 across a network 102 to a computer generically referred to herein as a server 104. The server 104 may include a database or be connected to a database that stores the identification of the wireless service together with the goods and services purchased by the consumer/user. At this point in time, there may not be any way for the server 104 to be able to determine what wireless device 106 is associated with the wireless service and the associated goods and services purchased with the wireless service by the consumer/user. Nevertheless, the database associated with server 104 may store the identification of the wireless service and any associated goods and services purchased.

The consumer/user after purchasing the wireless service may then take steps to utilize the purchased wireless service, such as use the authorization card and/or associated code to add airtime, to add service, activate service, and/or authorize service for the wireless device 106 as shown in 206 of FIG. 2. For example, the consumer/user can enter the authorization code into the wireless device 106. The wireless device 106 may transmit the authorization code to the network 102, to a mobile network 110 or the like. The transmitted authorization code may be verified by the server 104, a server provisioning wireless service to the user, or the like. Additionally, the server 104, the server provisioning wireless server to the user, or the like may respond to the user indicating that the code has been verified, airtime has been added, service has been added, service has been authorized, service has been activated, or the like. Other types of wireless service implementation, utilization and/or association with the wireless device 106 are contemplated as well and are within the spirit and scope of the invention.

Additionally, the wireless device 106 may include an application, memory, or the like (hereinafter application 108) that is configured to implement the authorization code transmission process or similar wireless service authorization process. For example, the application 108 may be a so called pre-paid engine. The application 108 may also receive a response from the server 104, the server provisioning wireless service to the user, or the like indicating that the code has been verified, airtime has been added, service has been added, service has been authorized, service has been activated or the like. The application 108 may also be configured to control use of the wireless device 106 based on an interaction with the server 104, the server provisioning wireless service to the user, or the like.

During this same authorization process, the server 104 may associate the identification of the purchased wireless service with a particular wireless device as shown in process 208. In this regard, the process 208 may receive a request from the consumer/user to add wireless service for particular wireless device 106 based on the purchased wireless service from a retail establishment as described above. The purchased wireless service having a particular identification. Accordingly, the consumer/user becomes associated with the purchased wireless service through, for example, the electronic identification number of the wireless device 106 during this process. For example, the process 208 may associate an International Mobile Equipment Identity (IMEI), a Mobile Equipment Identifier (MEID), phone number, or the like with the purchased wireless service through the identifying information associated with the purchased wireless service.

Accordingly, the system 100 and process 200 may be able to associate a consumer/user, the wireless device 106 of the consumer/user, the retail establishment that the consumer/user purchased the wireless service, and the associated goods and services purchased during this retail visit. This information or part of this information may be stored in a database that may be associated with the server 104 for future reference. Additionally, the information may be stored in a manner to retain the privacy of the consumer/user.

Once a particular consumer/user and their wireless device 106 have been determined as shown in process 208, the system 100 may determine previous purchase history of the consumer/user 210 based on previously stored information obtained in previous implementations of processes 202, 204, 206, and 208 if applicable. Accordingly, the system 100 may create a historical database of the consumer/user history of the retail establishments that the consumer/user frequents, the goods and services purchased by the consumer/user, and the time and date that the consumer/user visited the retail establishments.

As shown in process 212, the system 100 may be able to determine the next time the consumer/user will likely be purchasing wireless service. In this regard, a card having an authorization code, an authorization code (without a card), authorization of wireless service (without a card or code), or the like for wireless services associated with the wireless device 106 may have a predetermined preset amount of airtime and/or wireless service. For example, the authorization card may have 30 days, 60 days or the like of associated wireless service time. In that regard, the system 100 can determine with a high level of certainty that the consumer/user may need to purchase an additional authorization card, authorization code, additional wireless service, or the like 30 days, 60 days or the like from the time that the previous authorization card, authorization code, additional wireless service, or the like was obtained.

The process to 212 may use various statistical measures to determine the most likely time period, day of the week, and/or time of day to determine when a consumer/user will most likely shop next. The statistical measures may include the mean number of days to their wireless service ends, the mean day of week, the mean time of day, or the like. Other types of statistical measures may include probability distributions such as normal distributions, Poisson distributions, binomial distributions, exponential distributions and the like. The parameters may include a mean and a variance. Chi-squared distributions are contemplated as well.

Based on the determination of the prior retail location that the consumer/user purchased wireless service a set forth in 202, the determination of the previous purchasing history set forth in 210, in process 214 the system 100 may determine the likely next location consumer/user may purchase wireless service. In this regard, the system 100 may again employ statistical measures to determine the probability of the likely retail establishment that the consumer/user will most likely visit to purchase wireless service.

In process 216, the system 100 may determine products the mobile user may possibly purchase together with the wireless service. In particular, based on the historical data relating to previously purchased goods and services determined in 210, the system 100 may be able determine particular buying habits of the consumer/user. In this regard, the retail history may be divided into various types of retail purchases. For example, the prior retail purchases may be characterized as clothing, children's clothing, ladies clothing, men's clothing, automotive related products, cleaning products, home goods, and the like. Of course, the purchases may be characterized many different ways and such characterizations are within the spirit and scope of the invention. By performing statistical analysis on the types of historical retail purchases, process 216 may determine that similar types of purchases may be of interest to the consumer/user in the future.

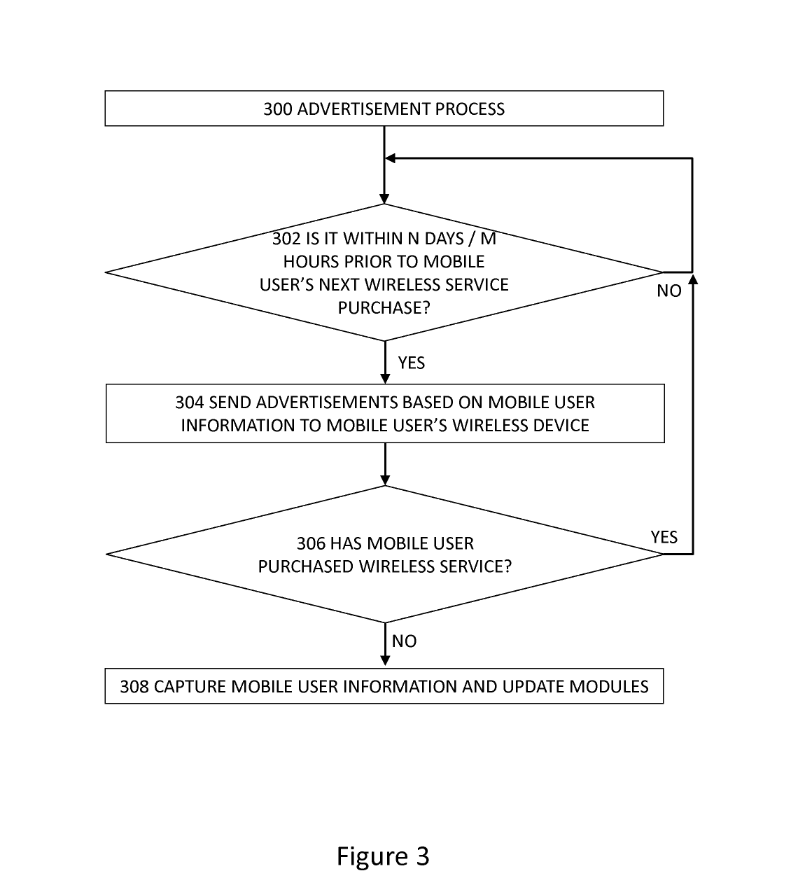

FIG. 3 shows an algorithm for providing advertisements to the consumer/user according to the invention. In particular, FIG. 3 shows an advertisement process 300 that may be implemented by the system 100 in conjunction with the process 200 of FIG. 2. More specifically, timing an advertisement may be beneficial. In this regard, process 302 may determine when it is within N days or M hours prior to consumer/user's most likely next wireless service purchase. When it is not within N days or M hours prior to consumer/user's most likely next wireless service purchase, the response to process 302 will be “No” and the process may loop until it is within N days or M hours prior to consumer/user's most likely next wireless service purchase. When it is within N days or M hours prior to consumer/user's most likely next wireless service purchase, the process 302 advances to process 304.

In process 304, the system 100 may provide an advertisement to the wireless device 106 of the consumer/user. The advertisement may be in the form of an e-mail, text message, digital coupon, or the display of some other form of digital content. In this regard, the wireless device 106 may alternatively or additionally include an advertisement application 116. The advertisement application 116 may be an application stored in the memory of the wireless device 106 that provides storage and access to the advertisement by the consumer/user. In this regard, the advertisement application 116 may be able to store and retrieve advertisements, coupons, and the like. The consumer/user may be able to access the advertisement application 116 to retrieve the advertisement, coupon, or the like for redemption during shopping. The advertisement application 116 may also interrupt some activities on the wireless device 106 in order to make the consumer/user aware of the particular advertisements and/or coupon. The interruption may include a sound output to further draw the attention of the advertisement and/or coupon to the consumer/user's attention.

In process 306, the system 100 may determine whether or not the consumer/user has purchased and authorized additional wireless service. If the consumer/user has not purchased and authorized wireless service, the process may loop and repeat the processes 302 and 304 so that the consumer/user may be repeatedly aware of the need to purchase wireless service and moreover provide the consumer/user with repeated advertisements and/or coupons. Once the consumer/user has purchased and authorized additional wireless service, the process 306 may advance to process 308 to discontinue advertisements. In that regard, the consumer/user will not be inundated with advertisements and/or coupons after they have purchased additional wireless service.

After purchasing the wireless service, process 308 may capture user information including the retail establishment in which the wireless service was obtained, the goods and services purchased during the shopping event associated with the wireless service and may update the server 104 with this data.

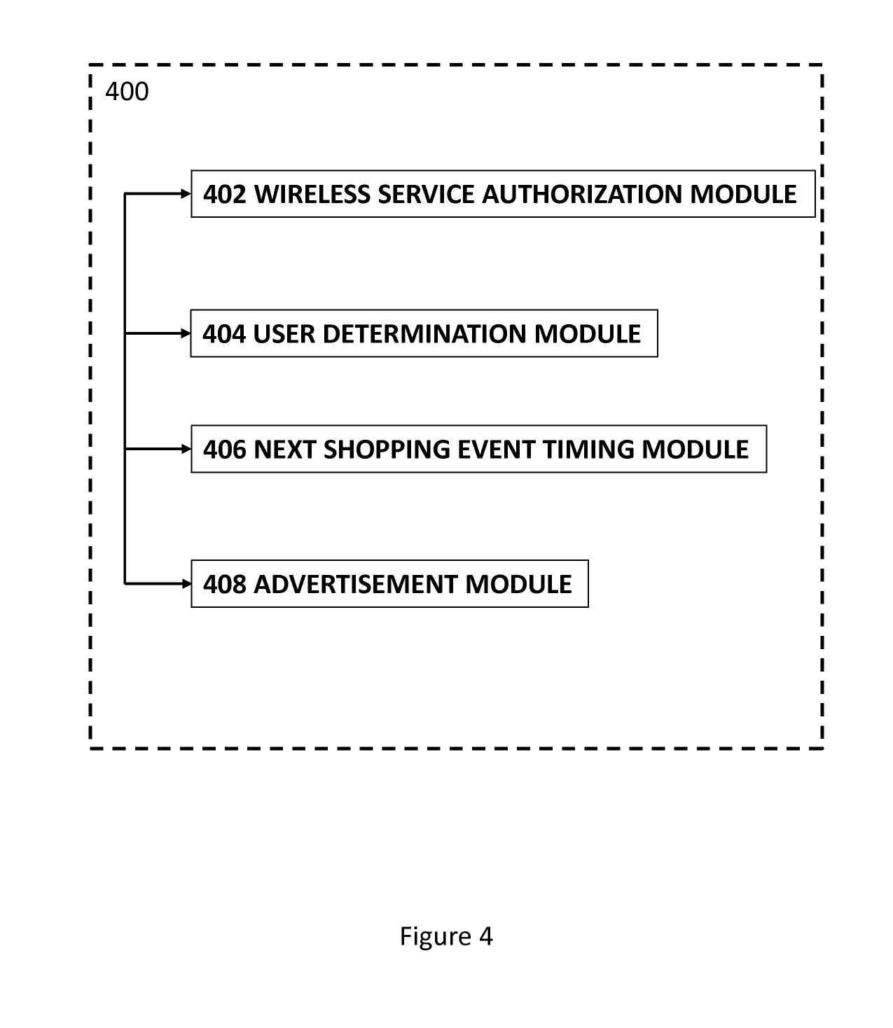

FIG. 4 is a schematic of a system for providing advertisements to consumers/users according to the invention. As may be appreciated by those skilled in the art, the illustrated structure of FIG. 4 is a logical structure and not a physical one. Accordingly, the illustrated modules can be implemented by employing various hardware and software components. In addition, two or more of the logical components can be implemented as a single module that provides functionality for the plural logical components. Also, the logical components can be subdivided into additional logical components. In one embodiment, the components are implemented as software program modules.

The logical structure 400 of FIG. 4 may include a wireless service authorization module 402, a user determination module 404, a next shopping event timing module 406, and an advertisement module 408. Other modules are within the scope and spirit of the invention.

The wireless service authorization module 402 may control authorization of wireless services with respect to the wireless device 106 of the consumer/user. In this regard, when the consumer/user purchases wireless service, the wireless service authorization module 402 may receive communication from the retail establishment and/or the consumer/user to provide or continue to provide wireless service to the consumer/user based on the purchased wireless service. The wireless service authorization module 402 may include capabilities to interact with the mobile network 110 and/or communicate with the wireless device 106 and/or application 108 to ensure the consumer/user is provided with wireless service for their wireless device 106 consistent with the purchased wireless service as described above in process 206 of FIG. 2. Other approaches to authorizing wireless service are within the spirit and scope of the invention as well.

The user determination module 404 may implement a user information capture process, such as the process 200 shown in FIG. 2. The user determination module 404 may determine a retail location that the consumer/user purchased wireless service. In particular, during the retail transaction that includes purchasing wireless service, data and/or information relating to the particulars of the wireless service may be entered into the point-of-sale during the retail transaction. The user determination module 404 may capture the information regarding the purchase of the wireless service.

The user determination module 404 may also capture and determine the various goods and services purchased together with the wireless service. In particular, when the consumer/user purchases the wireless service at a retail establishment, they may also purchase additional items of goods and services. In this regard, the retailer may provide this information to the user determination module 404 in a manner similar to the process 204 of FIG. 2.

Once the consumer/user purchases the wireless service, the mobile user may take steps to utilize or associate the purchased wireless service with their wireless device 106. The user determination module 404 may determine the wireless device 106 associated with the retail transaction that included the purchase of wireless service based on the subsequent utilization, authorization, or association of the purchased wireless service to the wireless device 106 in association with module 402.

Module 406 may be configured to determine the likely next shopping event by the consumer/user. In particular, module 406 may determine previous wireless service purchase history of the consumer/user associated with wireless device 106. Based on the history of the consumer/user, a history of the timing of their wireless service purchasing may be determined. Additionally, module 406 may determine the next likely time the consumer/user may be purchasing wireless service. In particular, the next shopping event timing module 406 may review the historical data and determine when it is most likely that the consumer/user will shop for additional wireless service. More specifically, the historical data will be analyzed for what day of the week is most historically prevalent for the consumer/mobile user, what time during the preset wireless service time period the consumer/user typically purchases additional wireless service, and the like. For example, the consumer/user may historically shop for their wireless service during the week that there current wireless service will end. Additionally, the module 406 may further determine that historically the consumer/user purchases wireless service on a Friday night during the week that their wireless service will end. The module 406 may use various statistical measures to determine the most likely time period, day the week, and/or time of day to determine when a consumer/user will most likely shop next. The statistical measures may include the mean number of days to their wireless service ends, the mean day of week, the mean time of day, or the like. Other types of statistical measures may include probability distributions such as normal distributions, Poisson distributions, binomial distributions, exponential distributions and the like. The parameters may include a mean and a variance. Chi-squared distributions are contemplated as well.

The module 406 may be further configured to determine the next likely location the mobile user will purchase wireless service. For example, the consumer/user previous retail history may be analyzed to determine the preferred retail establishments or the preferred set of retail establishments frequented by the consumer/user in order to determine the next likely location that the mobile user will purchase wireless service. Again various statistical measures as described above may be utilized to determine the next likely location based on historical data relating to of the retail history.

The advertisement module 408 may determine products that the consumer/user may possibly be interested in purchasing together with wireless service based on previous purchasing history. In particular, based on the historical data relating to previously purchased goods and services, advertisement module 408 may be able determine particular buying habits of the consumer/user. In this regard, the retail history may be divided into various types of retail purchases. For example, the prior retail purchases may be characterized as clothing, children's clothing, ladies clothing, men's clothing, automotive related products, cleaning products, home goods, and the like. Of course, the purchases may be characterized many different ways and such characterizations are within the spirit and scope of the invention. By performing statistical analysis on the types of historical retail purchases, advertisement module 408 may determine that similar types of purchases may be of interest to the consumer/user in the future.

Next, the advertisement module 408 may send advertisements to the consumer/user when it is determined to be a predetermined number of N days and/or predetermined number of hours M prior to the next likely wireless service purchase. The advertisement may be a text message sent to the wireless device 106, the advertisement may be some other form of digital content to be displayed on the wireless device 106 in conjunction with the advertisement application 116, or the like. The advertisement module 408 may send further advertisements in the hours and/or days that follow. The advertisement module 408 may further determine when the consumer/user has purchased wireless service and module 402 may execute the steps to associate or authorize the purchased wireless service for use with the wireless device 106 as shown in 206 of FIG. 2. Thereafter the advertisement module 408 may stop advertising in order to avoid inundating the consumer/mobile user with the too many advertisements.

Finally, the advertisement module 408 may capture the consumer/user information related to the most recent wireless purchase and associated purchase of goods and services and update the modules and server 104 accordingly.

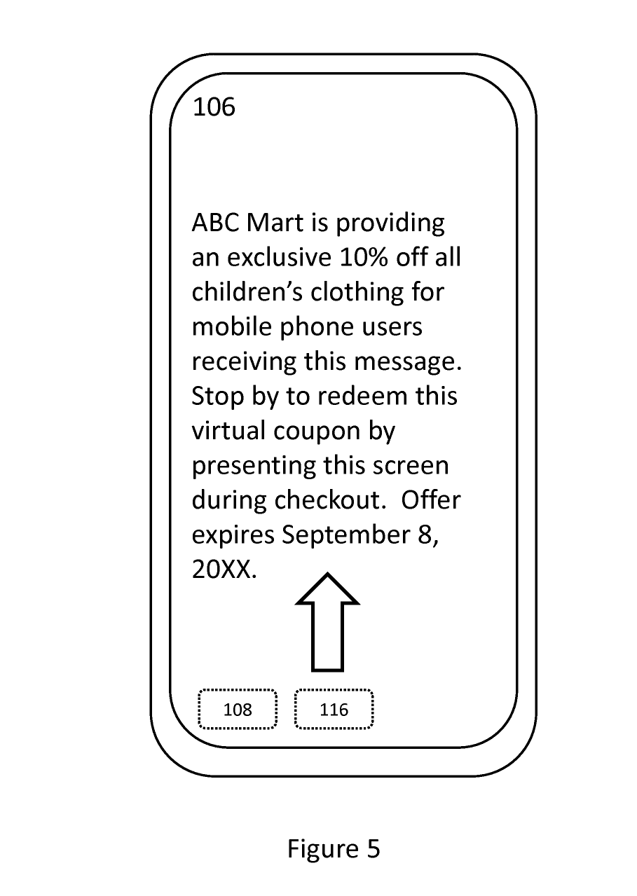

FIG. 5 shows an implementation of the process implemented on a wireless device according to the invention. As a particular example, a consumer/user may frequent ABC market in the last week that their wireless device 106 is authorized for wireless service. More specifically, the consumer/user may typically frequent ABC market on a Friday evening. When they shop at ABC market during this timeframe, they historically purchase one or more items characterized as children's related items such as diapers together with their wireless service. The wireless service they purchase may be a wireless service authorization card that provides 30 days of wireless service for their wireless device 106. Accordingly, the system 100 can predict that the consumer/user of the wireless device 106 is likely to return to ABC market in 30 days or less to purchase additional wireless service. Based on historical information, the system 100 can determine that it is likely that it will be a Friday evening in that last week. Additionally, the system 100 can determine that it is likely that the user may be interested in purchasing additional children's related items. As shown in FIG. 5, the system 100 may send a coupon to the consumer/user to encourage them to purchase other child related items such as children's clothing M hours before Friday evening in that last week of wireless service.

Accordingly, the invention provides a system and process for providing targeted mobile advertising based on purchasing patterns of users of prepaid wireless service. Moreover, the invention provides a system and process to deliver relevancy and immediacy to mobile advertising efforts. The invention allows for mobile advertising that targets users based on where they shop, how often they shop there, or when they will shop there again.

The invention may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, and/or the like, and/or a combination of two or more thereof.

The invention may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

In an embodiment, the invention may be web-based. For example, the server 104 may operate a web application to allow the invention to operate in conjunction with a database. The web application may be hosted in a browser-controlled environment (e.g., a Java applet and/or the like), coded in a browser-supported language (e.g., JavaScript combined with a browser-rendered markup language (e.g., Hyper Text Markup Language (HTML) and/or the like)) and/or the like such that any computer running a common web browser (e.g., Internet Explorer™, Firefox™, Chrome™, Safari™ or the like) may render the application executable. A web-based service may be more beneficial due to the ubiquity of web browsers and the convenience of using a web browser as a client (i.e., thin client). Further, with inherent support for cross-platform compatibility, the web application may be maintained and updated without distributing and installing software on each.

In an embodiment, the invention may be implemented in any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

Further in accordance with various embodiments of the invention, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A system configured to generate and send targeted advertising to wireless devices comprising:
a server configured to determine a retail location where wireless service for a wireless device has been purchased;
the server further configured to determine identifying information of the wireless device based on an authorization of the wireless service for the wireless device purchased at the retail location;
the server further configured to determine a previous history of purchasing wireless service associated with the wireless device of a consumer;
the server further configured to determine a next likely time the consumer will be purchasing the wireless service for the wireless device; and
the server further configured to send advertisements prior to the next likely time the consumer will be purchasing the wireless service for the wireless device.

2. The system according to claim 1 wherein the server is further configured to determine a next likely location the consumer will purchase the wireless service based on the previous history of purchasing wireless service associated with the wireless device of the consumer.

3. The system according to claim 1 wherein the server is further configured to at least one of obtain information regarding goods and services purchased together with the wireless service at the retail location, characterize the goods and services purchased together with the wireless service at the retail location, and store information regarding the goods and services purchased together with the wireless service at the retail location.

4. The system according to claim 1 wherein the server is further configured to determine products the consumer may possibly be interested in purchasing together with the wireless service based on a previous purchasing history.

5. The system according to claim 1 wherein the server is further configured to discontinue sending the advertisements once it is determined that the consumer has purchased and authorized the wireless service for the wireless device.

6. The system according to claim 1 wherein the wireless service comprises prepaid wireless service.

7. The system according to claim 1 wherein the advertisements comprises at least one of a text message, e-mail, digital coupon, and digital content delivered via an application.

8. A system configured to generate and send targeted advertising to wireless devices comprising:
means for determining a retail location where wireless service for a wireless device has been purchased;
means for identifying information of the wireless device based on an authorization of the wireless service for the wireless device purchased at the retail location;
means for determining a previous history of purchasing wireless service associated with the wireless device of a consumer;
means for determining a next likely time the consumer will be purchasing the wireless service for the wireless device; and
means for sending advertisements prior to the next likely time the consumer will be purchasing the wireless service for the wireless device.

9. The system according to claim 8 further comprising means for determining a next likely location the consumer will purchase the wireless service based on the previous history of purchasing wireless service associated with the wireless device of the consumer.

10. The system according to claim 8 further comprising at least one of means for obtaining information regarding goods and services purchased together with the wireless service at the retail location, means for characterizing the goods and services purchased together with the wireless service at the retail location, and means for storing information regarding the goods and services purchased together with the wireless service at the retail location.

11. The system according to claim 8 further comprising means for determining products the consumer may possibly be interested in purchasing together with the wireless service based on a previous purchasing history.

12. The system according to claim 8 further comprising means for discontinuing advertisements once it is determined that the consumer has purchased and authorized the wireless service for the wireless device.

13. The system according to claim 8 wherein the wireless service comprises prepaid wireless service.

14. The system according to claim 8 wherein the advertisements comprises at least one of a text message, e-mail, digital coupon, and digital content delivered via an application.

15. A process to generate and send targeted advertising to wireless devices from a computer system comprising:
determining a retail location where wireless service for a wireless device has been purchased utilizing the computer system;
identifying information of the wireless device based on an authorization of the wireless service for the wireless device purchased at the retail location utilizing the computer system;
determining a previous history of purchasing wireless service associated with the wireless device of a consumer utilizing the computer system;
determining a next likely time the consumer will be purchasing the wireless service for the wireless device utilizing the computer system; and
sending advertisements prior to the next likely time the consumer will be purchasing the wireless service for the wireless device utilizing the computer system.

16. The process according to claim 15 further comprising determining a next likely location the consumer will purchase the wireless service based on the previous history of purchasing the wireless service associated with the wireless device of the consumer.

17. The process according to claim 15 further comprising at least one of an obtaining information regarding goods and services purchased together with the wireless service at the retail location, characterizing the goods and services purchased together with the wireless service at the retail location, and storing information regarding the goods and services purchased together with the wireless service at the retail location.

18. The process according to claim 15 comprising determining products the consumer may possibly be interested in purchasing together with the wireless service based on a previous purchasing history.

19. The process according to claim 15 comprising discontinuing advertisements once it is determined that the consumer has purchased an authorized the wireless service for the wireless device.

20. The process according to claim 15 wherein the wireless service comprises prepaid wireless service and wherein the advertisements comprises at least one of a text message, e-mail, digital coupon, and digital content delivered via an application.
